(19) United States
(12) Patent Application Publication
(10) Pub. No.: US 2013/0220083 A1
(43) Pub. Date: Aug. 29, 2013

(54) Kitchen Sink Strainer Basket Wrench

(71) Applicant: Roger Dale West, Eudora, AR (US)

(72) Inventor: Roger Dale West, Eudora, AR (US)

(21) Appl. No.: 13/598,602

(22) Filed: Aug. 29, 2012

Related U.S. Application Data
(60) Provisional application No. 61/529,159, filed on Aug. 30, 2011.

(51) Int. Cl. B25B 13/50

(52) U.S. Cl. CPC B25B 13/50
USPC 81/175; 81/52; 29/525.11; 29/426.5

(57) ABSTRACT

A tool adapted to install and remove strainer basket assemblies. The tool has a tubular main body that incorporates a means for gripping the upper strainer nut on a strainer basket assembly. The tool also has a moveable shaft that incorporates a means for gripping a strainer basket assembly. The tool is used to assemble a strainer basket assembly by attaching the tool's upper strainer nut gripping means to a upper strainer nut, attaching the tool's strainer basket gripping means to a strainer basket assembly, and applying a force to the tubular main body and an opposing force to the moveable shaft to tighten the upper strainer nut. The tool is used to disassemble and remove a previously installed strainer basket assembly by attaching the tool's upper strainer nut gripping means to an upper strainer nut, attaching the strainer basket gripping means to a strainer basket assembly, and applying a force to the tubular main body and an opposing force to the moveable shaft to loosen the upper strainer nut.

### PRIORITY

This application claims the priority date of U.S. Provisional Patent Application No. 61529159, filed Aug. 30, 2011 and incorporated herein by reference.

### BACKGROUND OF THE INVENTION

Sinks, showers, and bath tubs typically include a drain opening connected to disposal lines. The drain opening is often fitted with a strainer basket assembly. The strainer basket assembly is situated at the bottom of the sink and contains an aperture that serves as a conduit for directing water out of the sink and into a drain pipe situated underneath the sink and connected to the strainer basket assembly.

A strainer basket assembly includes a relatively large diameter upper portion which may receive a basket for receiving and draining waste materials. The large diameter upper portion of the strainer basket assembly is externally threaded and receives a threaded upper strainer nut which secures the strainer basket assembly to the bottom of the sink. The strainer basket assembly also includes a lower small diameter portion extending downwardly from the large diameter upper portion which may receive a stopper to retain water in the sink. The lower small diameter portion is externally threaded for connection to the drain pipe. The inside of the lower portion of the strainer basket typically includes a series of cross bars that prevent large items from clogging the drain opening.

Although commonly used, strainer baskets assemblies have been difficult to install, especially when the sink is already installed. Strainer basket assemblies are also difficult to remove, especially when the components have corroded over time. There is a need for a tool that allows a single user to easily install or remove strainer basket assemblies.

### SUMMARY OF THE INVENTION

The kitchen sink strainer basket wrench is a tool specifically adapted to install and remove strainer basket assemblies. The tool has a tubular main body that incorporates a means for gripping the upper strainer nut on a strainer basket assembly. The tool also has a moveable shaft that incorporates a means for gripping a strainer basket assembly. The tool provides for a method of assembling a strainer basket assembly by attaching the tool's tubular main body to the upper strainer nut, attaching the tool's strainer basket gripping means to the strainer basket assembly, and applying a force to the tubular main body and an opposing force to the moveable shaft to tighten the upper strainer nut.

The kitchen sink strainer basket wrench also provides for a method of disassembling a previously installed strainer basket assembly by attaching the tubular main body to the upper strainer nut, attaching the strainer basket gripping means to the strainer basket aperture, and applying a force to the tubular main body and an opposing force to the moveable shaft to loosen the upper strainer nut.

### BRIEF DESCRIPTION OF THE SEVERAL VIEWS OF THE DRAWINGS

FIG. 1 is a perspective view of a disassembled strainer basket assembly.

FIG. 2 is a cut-away view of the kitchen sink strainer basket wrench.

FIG. 3 is a cut-away view of the kitchen sink strainer basket wrench.

FIG. 4 is a perspective view of the kitchen sink strainer wrench and a strainer basket assembly attached to a sink.

### DETAILED DESCRIPTION

As used in this description and the appended claims, the phrase “upper strainer nut” includes a threaded fastener used to attach a strainer basket assembly to a sink basin. A series of evenly spaced vertical ridges are typically molded into the outer diameter of an upper strainer nut.

As used in this description and the appended claims, the phrase “upper strainer nut gripping means” includes a plurality of retractable threaded thumb screws that are evenly spaced around the upper end of the tool's tubular main body. The aperture defined by the tool's tubular main body may be placed over an upper strainer nut and the thumb screws may be tightened, gripping the upper strainer nut and holding the tool in place. The phrase “upper strainer nut gripping means” also includes a series of evenly spaced notches in the upper end of the tool's tubular main body, where the notches are adapted to receive and grip the vertical ridges of an upper strainer nut.

As used in this description and the appended claims, the phrase “strainer basket gripping means” includes one or more hooks adapted to engage the cross bars at the lower end of a strainer basket assembly. The phrase “strainer basket gripping means” also includes a threaded nut adapted to engage the lower threaded end of a strainer basket assembly.

As used in this description and the appended claims, the phrase “gripping tool flats” includes opposed planar surfaces that can be manipulated with a traditional adjustable wrench or pliers.

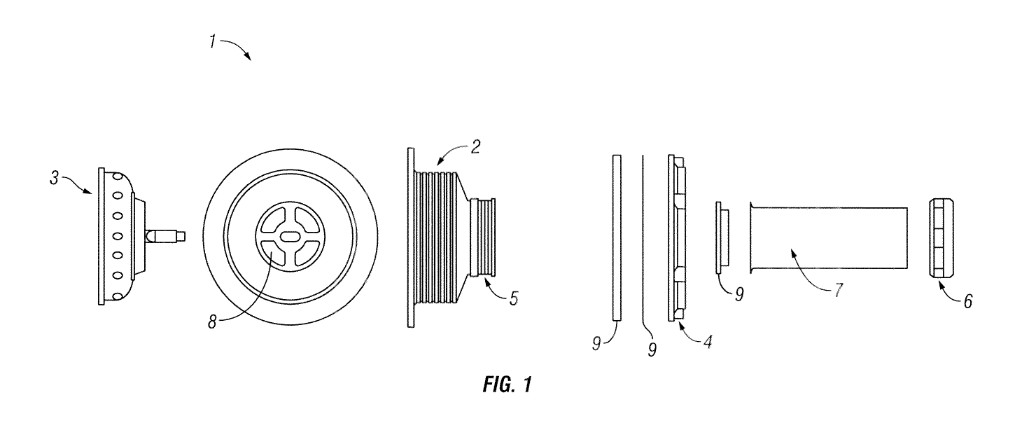

The kitchen sink strainer basket wrench is a plumbing tool adapted to install and remove strainer basket assemblies. FIG. 1 is a perspective view of a typical disassembled strainer basket assembly 1. The strainer basket assembly 1 includes a relatively large diameter upper portion 2 which may receive a basket 3 for receiving and draining waste materials. The large diameter upper portion 2 of the strainer basket assembly 1 is externally threaded and receives a threaded upper strainer nut 4 which secures the strainer basket assembly 1 to the bottom of a sink. The strainer basket assembly 1 also includes a lower small diameter portion 5 extending downwardly from the large diameter upper portion 2. The lower small diameter portion 5 is externally threaded to receive a lower basket nut 6. The lower basket nut 6 receives and secures a drain pipe 7. The inside of the lower portion 5 of the strainer basket assembly 1 typically includes a series of cross bars 8 that prevent large items from clogging the drain opening. The strainer basket assembly 1 may also contain various washers 9 for preventing leaks.

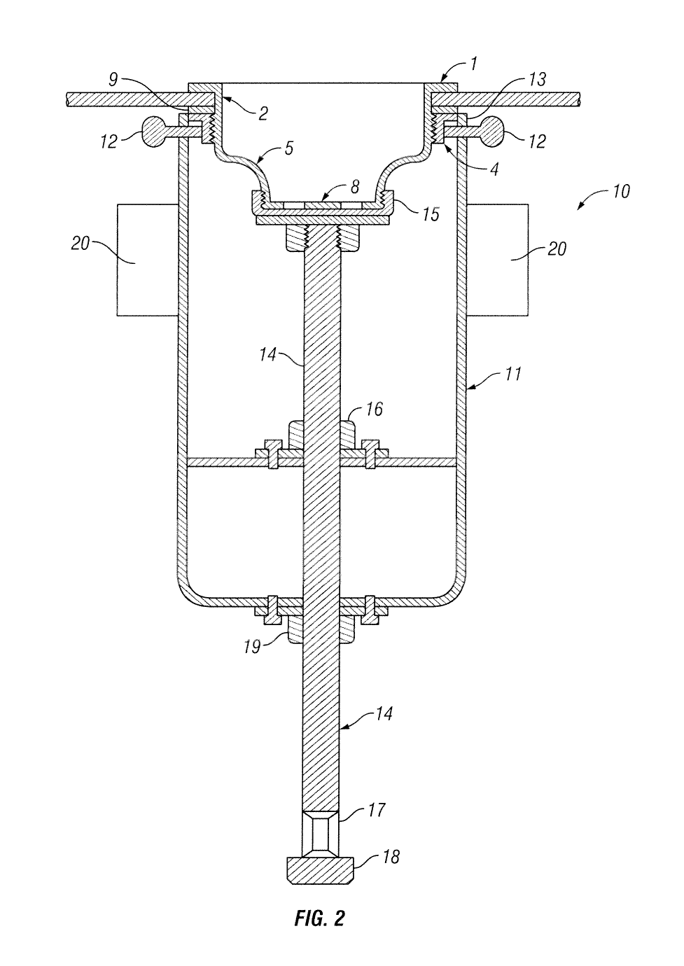

FIG. 2 is a cut-away view of the kitchen sink strainer basket wrench 10. The wrench 10 is comprised of a tubular main body 11, an upper strainer nut gripping means 12 on the upper rim 13 of the tubular main body 11, a moveable shaft 14 centered within the tubular main body 11 and protruding below the tubular main body 11, and a strainer basket gripping means 15 attached to the upper end of the moveable shaft 14.

The tubular main body 11 is larger in diameter than a strainer basket assembly 1. At the upper end 13 of the tubular main body 11 is the upper strainer nut gripping means 12. In one embodiment, the upper strainer nut gripping means 12 is comprised of a series of retractable threaded thumb screws 12. The thumb screws 12 may be tightened to grip the upper strainer nut 4 of a strainer basket assembly 1. The upper strainer nut gripping means 12 may further comprise a plurality of notches in the upper rim 13 of the tubular main body 11, where the notches are adapted to receive and grip protrusions on an upper strainer nut 4.

The moveable shaft 14 is centrally held in the tubular main body 11 by at least one bushing 16. The bushing 16 allows the moveable shaft 14 to rotate in any direction and move up and down. A strainer basket gripping means 15 is attached to the upper end of the moveable shaft 14. In one embodiment, the strainer basket gripping means 15 comprises a threaded nut adapted to engage threads on the lower small diameter portion 5 of a strainer basket assembly 1.

The lower end of the moveable shaft 14 protrudes through the bottom of the tubular main body 11. The moveable shaft 14 includes a means to allow a user to grip and rotate the shaft 14. The moveable shaft 14 gripping and rotating means may include but are not limited to a set of gripping tool flats 17 or a hex bolt head 18. In another embodiment, a handle could be attached to the moveable shaft 14 to allow the a user o rotate the shaft 14.

The tubular main body 11 also incorporates means to allow a user to grip and rotate the tubular main body 11. In one embodiment, the main body 11 gripping and rotating means includes a set of gripping tool flats 19 incorporated into the tubular main body 11. The tubular main body 11 may also incorporate at least one wedge 20 for gripping and rotating the main body 11. The wedge 20 could also be struck with a hammer or similar striking tool to free a stuck upper strainer nut 4. In another embodiment, the main body 11 gripping and rotating means could comprise a handle attached to the tubular main body 11. In another embodiment, the main body 11 gripping and rotating means could comprise one or more apertures formed in the tubular main body 11, where the apertures are adapted to receive a screwdriver or similar lever to which the user may apply torque to rotate the tubular main body 11.

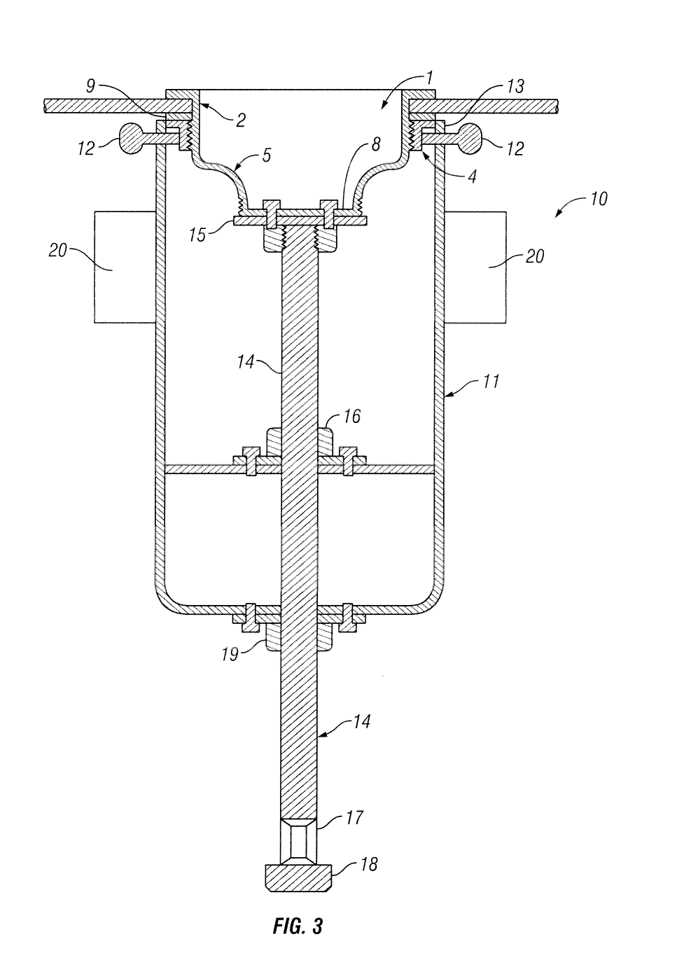

FIG. 3 is a cut-away view of another embodiment of the kitchen sink strainer basket wrench 10. In this embodiment, the strainer basket gripping means 15 comprises a set of hooks adapted to engage the cross bars 8 in the lower end 5 of the strainer basket assembly 1.

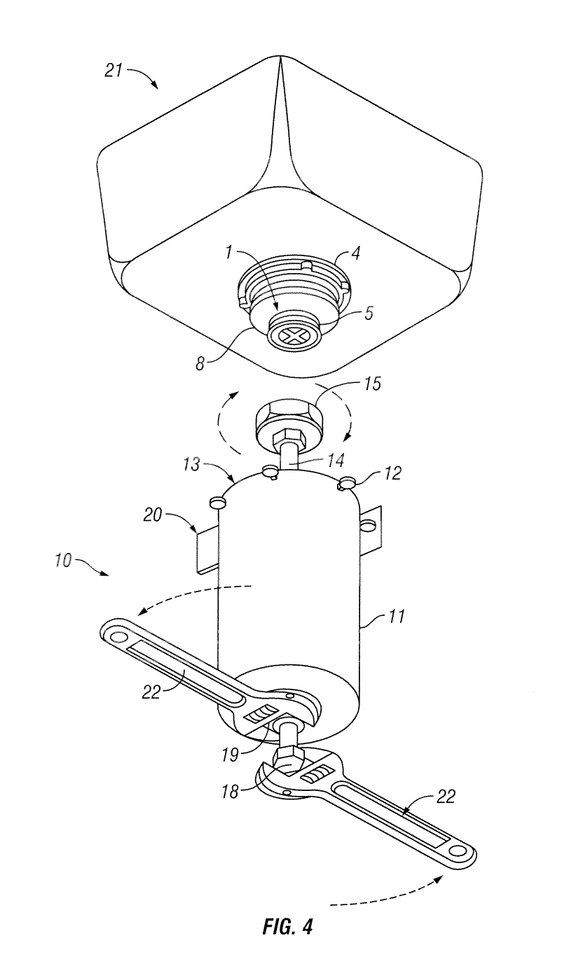

FIG. 4 is a perspective view of the kitchen sink strainer basket wrench 10 and a strainer basket assembly 1 attached to a sink 21. To use the kitchen sink strainer basket wrench 10 to remove a strainer basket assembly 1, a user would first position the tubular main body 11 over an upper strainer nut 4. Next, the upper strainer nut gripping means 12 is placed onto the upper strainer nut 4. In FIG. 4, the upper strainer nut gripping means 12 is a plurality of retractable threaded thumb screws that are tightened to grip the upper strainer nut 4. When tightened, the thumb screws also serve to hold the wrench 10 in place and prevent the wrench 10 from slipping off the strainer basket assembly 1. The user then attaches the strainer basket gripping means 15 to the lower small diameter portion 5 of the strainer basket assembly 1. The strainer basket gripping means 15 in FIG. 4 comprises a threaded nut that is screwed onto the external threads of the lower small diameter portion 5 of the strainer basket assembly 1. If the strainer basket gripping means 15 is a set of hooks as depicted in FIG. 3, the hooks are inserted between the strainer basket cross bars 8. Finally, force is applied in one direction to the tubular main body 11 and force is applied in an opposing direction to the moveable shaft 14 to loosen the upper strainer nut 4. In FIG. 4, the force is applied using one wrench 22 to turn gripping tool flats 19 incorporated into the tubular main body 11 and using another wrench 22 to turn a hex bolt head 18 incorporated into the lower end of the moveable shaft 14.

The kitchen sink strainer wrench 10 may also be used to assemble a strainer basket assembly 1. To assemble a strainer basket assembly 1, a user would first position the tubular main body 11 over an upper strainer nut 4. Next, the upper strainer nut gripping means 12 is placed onto the upper strainer nut 4. The user then attaches the strainer basket gripping means 15 to the lower small diameter portion 5 of the strainer basket assembly 1. Finally, force is applied in one direction to the tubular main body 11 and force is applied in an opposing direction to the moveable shaft 14 to tighten the upper strainer nut 4.

The foregoing description of preferred embodiments for the kitchen sink strainer basket wrench invention is presented for the purposes of illustration and description. They are not intended to be exhaustive or to limit the invention to the precise form disclosed. Obvious modifications or variations are possible in light of the above teachings. The embodiments are chosen and described in an effort to provide the best illustration of the principles of the invention and its practical applications, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A plumbing tool comprising:
a tubular main body;
an upper strainer nut gripping means on the upper rim of the tubular main body;
a moveable shaft centered within the tubular main body and protruding below the tubular main body; and
a strainer basket gripping means attached to the upper end of the moveable shaft.

2. The plumbing tool of claim 1, further comprising the upper strainer nut gripping means being a plurality of retractable thumb screws that may be tightened to grip the upper strainer nut of a strainer basket assembly.

3. The plumbing tool of claim 1, further comprising the upper strainer nut gripping means being a plurality of notches in the upper end of the tubular main body, where the notches are adapted to receive and grip protrusions on an upper strainer nut.

4. The plumbing tool of claim 1, further comprising a set of gripping tool flats incorporated into the tubular main body to allow a user to grip and turn the tubular main body.

5. The plumbing tool of claim 1, further comprising a handle attached to the tubular main body to allow a user to grip and turn the tubular main body.

6. The plumbing tool of claim 1, further comprising at least one wedge attached to the outside of the tubular main body to allow a user to grip and turn the tubular main body.

7. The plumbing tool of claim 1, further comprising at least one aperture formed in the tubular main body, where the aperture is adapted for receiving a lever, and the lever may be used to apply force to turn the tubular main body.

8. The plumbing tool of claim 1, further comprising the moveable shaft being centrally held in the tubular main body with at least one bushing, where the bushing allows the moveable shaft to rotate in any direction and move up and down.

9. The plumbing tool of claim 1, further comprising a set of gripping tool flats incorporated into the lower end of the moveable shaft to allow for gripping and turning the moveable shaft.

10. The plumbing tool of claim 1, further comprising a hex bolt head attached to the lower end of the moveable shaft to allow for gripping and turning the moveable shaft.

11. The plumbing tool of claim 1, further comprising a handle attached to the moveable shaft to allow for gripping and turning the moveable shaft.

12. The plumbing tool of claim 1, further comprising the strainer basket gripping means being a threaded out adapted for threading onto the lower threaded end of the strainer basket assembly.

13. The plumbing tool of claim 1, further comprising the strainer basket gripping means being one or more hooks adapted to engage cross bars in the lower end of a strainer basket assembly.

14. A method of assembling a strainer basket assembly using the plumbing tool of claim 1, comprising the steps of:
attaching the tubular main body to an upper strainer nut using the upper strainer nut gripping means,
attaching the strainer basket gripping means to the lower small diameter portion of the strainer basket assembly,
applying a force to the tubular main body and an opposing force to the moveable shaft; and
tightening the upper strainer nut.

15. A method of disassembling a strainer basket assembly using the plumbing tool of claim 1, comprising the steps of:
attaching the tubular main body to an upper strainer nut using the upper strainer nut gripping means,
attaching the strainer basket ripping means to the lower small diameter portion of the strainer basket assembly.
applying a force to the tubular main body and an opposing force to the moveable shaft; and
loosening the upper strainer nut.
